(19) United States
(12) Patent Application Publication
(10) Pub. No.: US 2022/0407320 A1
(43) Pub. Date: Dec. 22, 2022

(54) BATTERY PACK WITH INTEGRAL CHARGING PORT

(71) Applicant: Taiga Motors Inc., Lasalle (CA)

(72) Inventors: Dante FILICE, Lasalle (CA); Gabriel BERNATCHEZ, Lasalle (CA); Jessie BOUDREAU, Lasalle (CA)

(73) Assignee: Taiga Motors Inc., Lasalle (CA)

(21) Appl. No.: 17/752,125

(22) Filed: May 24, 2022

Related U.S. Application Data
(60) Provisional application No. 63/212,331, filed on Jun. 18, 2021.

(51) Int. Cl. H02J 7/00; H02J 7/02; H01M 50/204; H01M 50/249; H01M 10/46; H01M 10/0525; B60L 50/61; B60L 53/20; B60L 53/16

(52) U.S. Cl. CPC H02J 7/0042; H02J 7/0013; H02J 7/02; H01M 50/204; H01M 50/249; H01M 10/46; H01M 10/0525; B60L 50/61; B60L 53/20; B60L 53/16; H02K 11/0094

(57) ABSTRACT

One example provides a battery pack for an electric vehicle. The battery pack includes a plurality of rechargeable battery modules, an enclosure defining an interior space in which the plurality of rechargeable battery modules are enclosed, and a charging port mounted to the enclosure, the charging port electrically connected within the enclosure to the plurality of rechargeable battery modules, the charging port accessible from an exterior of the enclosure and configured to electrically connect an external electrical charging source to the plurality of rechargeable battery modules.

### CROSS-REFERENCE TO RELATED APPLICATIONS

The application claims priority from U.S. Provisional Patent Application No. 63/212,331, filed Jun. 18, 2021, the contents of which are incorporated by reference in their entirety herein.

### FIELD OF THE INVENTION

This disclosure relates generally to electric vehicles (EVs).

### BACKGROUND

Electric vehicles, including electric powersport vehicles (e.g., all-terrain vehicles (ATVs), personal watercraft (PWC), and snowmobiles), employ electric powertrains which typically include a battery system, one or more electric motors, and various auxiliary systems (e.g., heating/cooling systems). Efficiencies in size, weight, and durability improve vehicle performance (e.g., reliability and functionality), particularly for electric powersport vehicles, where space and endurance are at a premium.

### SUMMARY

One example provides a battery pack for an electric vehicle. The battery pack includes a plurality of rechargeable battery modules, an enclosure defining an interior space in which the plurality of rechargeable battery modules are enclosed, and a charging port mounted to the enclosure, the charging port electrically connected within the enclosure to the plurality of rechargeable battery modules, the charging port accessible from an exterior of the enclosure and configured to electrically connect an external electrical charging source to the plurality of rechargeable battery modules.

Another example provides a battery pack for an electric vehicle. The battery pack includes a plurality of rechargeable battery modules, DC circuitry to electrically connect the plurality of rechargeable battery modules to an electric motor of the electric vehicle, an enclosure housing the plurality of battery modules and DC circuitry, and a DC charging port mounted to the enclosure and directly connected to the DC circuitry. The DC charging port is accessible from an exterior of the enclosure and configured to receive and electrically connect an external DC charging source to the plurality of rechargeable battery modules via the DC circuitry.

One example provides an electric power sport vehicle including a body, an electric motor disposed within the body for propelling the vehicle, and a battery pack disposed within the body for powering the electric motor. In examples, the battery pack includes a plurality of rechargeable battery modules, DC circuitry to electrically connect the plurality of rechargeable battery modules to the electric motor, the DC circuitry including a pair of DC charging contactors, an enclosure housing the plurality of battery modules and DC circuitry, and a DC charging port. In one example, the DC charging port is mounted to the enclosure and directly connected to the DC circuitry, the DC charging port accessible from an exterior of the enclosure and from an exterior of the body and configured to receive and electrically connect an external DC charging source to the plurality of rechargeable battery modules via at least the pair of DC charging contactors.

Additional and/or alternative features and aspects of examples of the present technology will become apparent from the following description, the accompanying drawings, and the appended claims.

### BRIEF DESCRIPTION OF THE DRAWINGS

FIG. 1A generally illustrates an electric vehicle, in particular, an electric snowmobile, including a battery pack in accordance with one example of the present disclosure.

FIG. 1B is a perspective view illustrating an example of a motor and braking system of the electric snowmobile of FIG. 1A.

FIG. 2 is a block and schematic diagram generally illustrating a battery pack, according to one example.

FIGS. 3A and 3B are block diagrams generally illustrating a top plate assembly, according to one example.

FIG. 4 is a block and schematic wiring diagram of a battery pack, according to one example.

FIG. 5 is a block and schematic wiring diagram of a battery pack, according to one example.

FIG. 6 is a block and schematic wiring diagram of a battery pack, according to one example.

FIG. 7 is a block and schematic wiring diagram of a battery pack, according to one example.

FIGS. 8A and 8B are perspective views of a battery pack with and without a housing, according to one example.

FIG. 9A is a top perspective view of a top plate assembly, according to one example.

FIG. 9B is a side view of the top plate assembly of FIG. 9A, according to one example.

FIG. 9C is a top view of the top plate assembly of FIG. 9A, according to one example.

FIG. 9D is a bottom view of the top plate assembly of FIG. 9A, according to one example.

FIG. 9E is a bottom perspective view of the top plate assembly of FIG. 9A, according to one example.

FIG. 10A is a perspective view of portions of an electric snowmobile, including a charging port unit, according to one example.

FIG. 10B is an enlarged perspective view of charging port unit of FIG. 10A, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Electric vehicles, including electric powersport vehicles (e.g., all-terrain vehicles (ATVs), personal watercraft (PWC), and snowmobiles), employ electric powertrains which typically include a battery pack, one or more electric motors, and various auxiliary systems (e.g., heating/cooling systems). Efficiencies in size, weight, and durability improve vehicle performance (e.g., reliability and functionality), particularly for electric powersport vehicles where space and endurance are at a premium.

EVs typically include a charging port which is selectively connectable to an external charging source to charge the battery pack. Such charging ports may include a DC charging port and/or an AC charging port, where the DC charging port is selectively connectable to an external DC charging source, and the AC charging port is selectively connectable to an external AC power source. In known configurations, such charging ports are typically disposed at a location on the body of the vehicle that provides convenient access for connection. As a result, known charging ports, including AC and DC charging ports, are remotely located from the battery pack and are electrically connected thereto by wiring routed through the body of the vehicle. Such wiring consumes space within the body, introduces electrical losses in the charging system due to a length of the conductors, and represents a potential failure point due to vibration and vehicle impacts during operation, particularly in the case of the EV being a powersport vehicle.

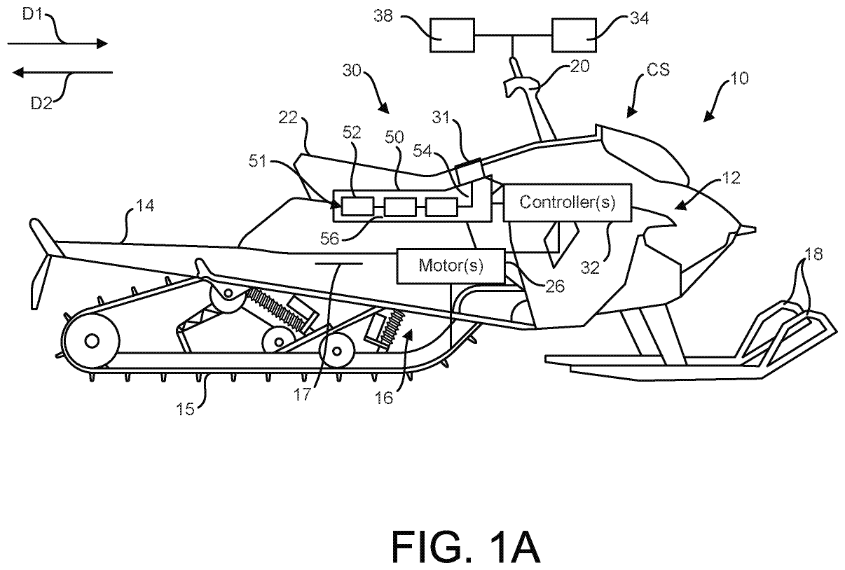

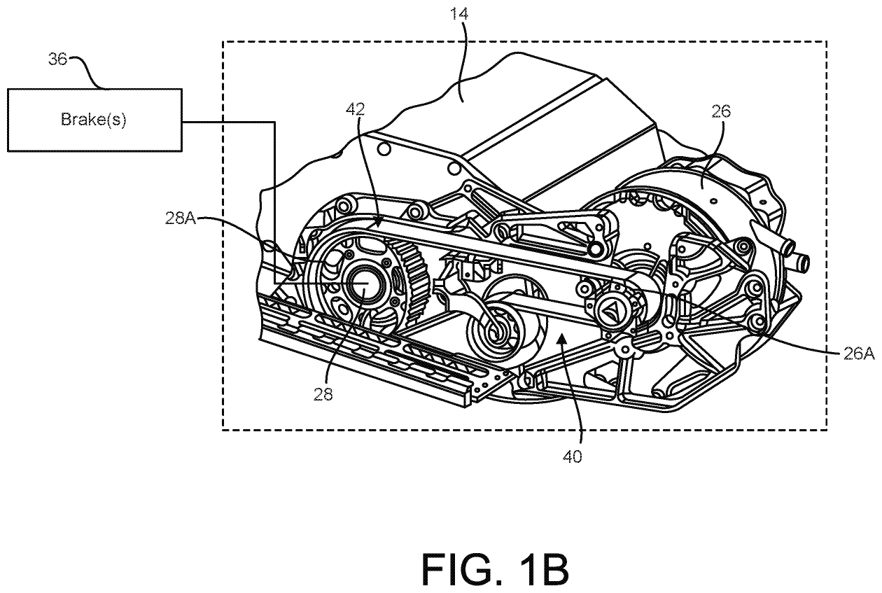

FIG. 1 is a block and schematic diagram generally illustrating an electric vehicle 10, in this case a snowmobile, employing a battery pack 30 having an integral charging port 31, in accordance with the present disclosure. As will be described in greater details below, in some examples, charging port 31 includes a DC charging port 60 and/or an AC charging port 78. Although illustrated and described herein primarily as a snowmobile, electric vehicle 10 may be any number of other types of electric vehicle, including other types of off-road and powersport vehicles such as personal watercraft (PWC), all-terrain vehicles (ATVs), and utility task vehicles (UTVs) including side-by-side vehicles, for example. In some embodiments, the snowmobile 10 includes elements of a snow vehicle described in International Patent Application no. WO 2019/049109 A1 entitled “Battery Arrangement for Electric Snow Vehicles”, and U.S. Patent Application No. 63/135,497 entitled “Electric Vehicle With Battery Pack as a Structural Element”, the entirety of which are incorporated herein by reference.

In examples, snowmobile 10 may include a frame 12 (also known as a chassis) which may include a tunnel 14, a drive track 15 having the form of an endless belt for engaging the ground (e.g., snow) and disposed under the tunnel 14, and a powertrain 16 mounted to the frame 12 and configured to displace the drive track 15. Left and right skis 18 are disposed in a front portion of the snowmobile 10, and a straddle seat 22 is disposed above the tunnel 14 for accommodating an operator of the snowmobile 10 and optionally one or more passengers. Left and right skis 18 may be movably attached to the frame 12 to permit steering of snowmobile 10 via a steering assembly including a steering column connected to handlebar 20.

In examples, powertrain 16 includes an electric motor (or motors) 26 drivingly coupled to drive track 15 via a drive shaft. In one embodiment, the electric motor 26 has a maximum output power of between 120 and 180 horse power. In other embodiments, electric motor 26 has a maximum output power of at least 180 horse power. The drive shaft may be drivingly coupled to the drive track 15 via one or more toothed wheels or other means to transfer motive power from electric motor 26 to the drive track 15. Powertrain 16 also includes battery pack 30 for providing an electric current to drive electric motor 26. In examples, the operation of electric motor 26 and the delivery of drive current to the electric motor 26 from the battery pack 30 may be controlled by a controller 32 based on an actuation of an input device 34, sometimes referred to as a “throttle”, by the operator. The controller 32 and the input device 34 are part of a control system CS for controlling operation of the snowmobile 10. In some embodiments, the battery 30 may be a lithium ion or other type of battery pack 30.

With additional reference to FIG. 1B, the snowmobile 10 may also include one or more brake(s) 36 that may be applied or released by an actuation of a brake actuator 38 (e.g., lever) by the operator for example. The brake 36 may be operable as a main brake for the purpose of slowing and stopping the snowmobile 10 during motion of the snowmobile 10. Brake 36 may comprise a combination of tractive braking and regenerative braking. In some examples, the 36 may be operable as described in U.S. patent application Ser. No. 17/091,712 entitled “Braking System for an Off-Road Vehicle”, the entirety of which is incorporated herein by reference. Alternatively or in addition, brake 36 may be operable as a parking brake, sometimes called “e-brake” or “emergency brake”, of snowmobile 10 intended to be used when the snowmobile 10 is stationary. In some examples, such main and parking brake functions may use separate brakes, or may use a common brake 36.

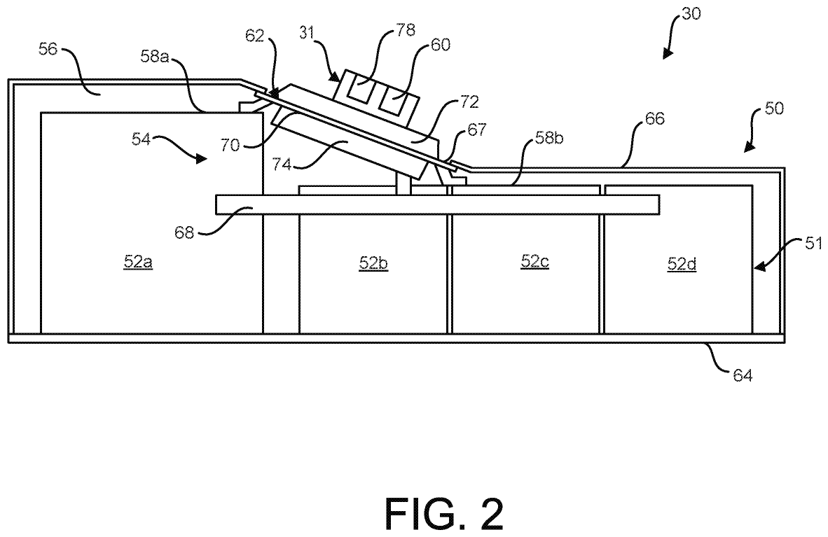

In examples, electric motor 26 is in torque-transmitting engagement with the drive shaft 28 via a transmission 40. Transmission 40 may be of a belt/pulley type, a chain/sprocket type, or a shaft/gear type for example. Referring to FIG. 2B, the transmission 40 is of a belt/pulley type. Transmission 40 includes a drive belt 42 that is mounted about a motor output 26A of electric motor 26, and is also mounted about a drive wheel 28A for driving drive shaft 28. In some examples, drive belt 42 may be a chain belt. The drive belt 42 therefore extends between and connects the motor output 26A and the drive wheel 28A for conveying torque from electric motor 26 to drive shaft 28. Drive belt 42 is thus displaced or driven by the motor output 26A in a linear manner between motor output 26A and drive wheel 28A, and in a circumferential manner about motor output 26A and drive wheel 28A.

In examples, at least one input device 34 is operatively connected to controller 32. Controller 33 is operable for modulating an electrical output transmitted from battery pack 30 to the electric motor 26 as a function of a signal received from the input device 34, among other inputs. In examples, controller 32 is operable for controlling a rotational speed and acceleration of the electric motor 26 and, thus, a thrust of drive track 15. Input device 34 may be located on handlebar 20 or at other suitable location(s), such as on a foot rest 17 of the snowmobile 10. A direction of rotation of motor output 26A of electric motor 26 may be selected with the input device 34 in order to propel the snowmobile 10 in a selected one of a forward direction D1 and a rearward direction D2.

Electric motor 26 has a forward configuration in which motor output 26A rotates in a first direction R1 (FIG. 1) to propel the snowmobile 10 in forward direction D1, and has a rearward configuration in which the motor output 26A rotates in a second direction R2 (FIG. 1) opposite the first direction R1 to propel snowmobile 10 in rearward direction D2. In examples, input device 34 is engageable to operate electric motor 26 in a selected one of the forward and rearward configurations to respectively propel snowmobile 10 in the forward and rearward directions D1, D2 with the electric motor 26. In examples, controller 32 is operable to invert a polarity of a current supplied from the battery 30 to the electric motor 26 to change a direction of rotation of the motor output 26A of the electric motor 26.

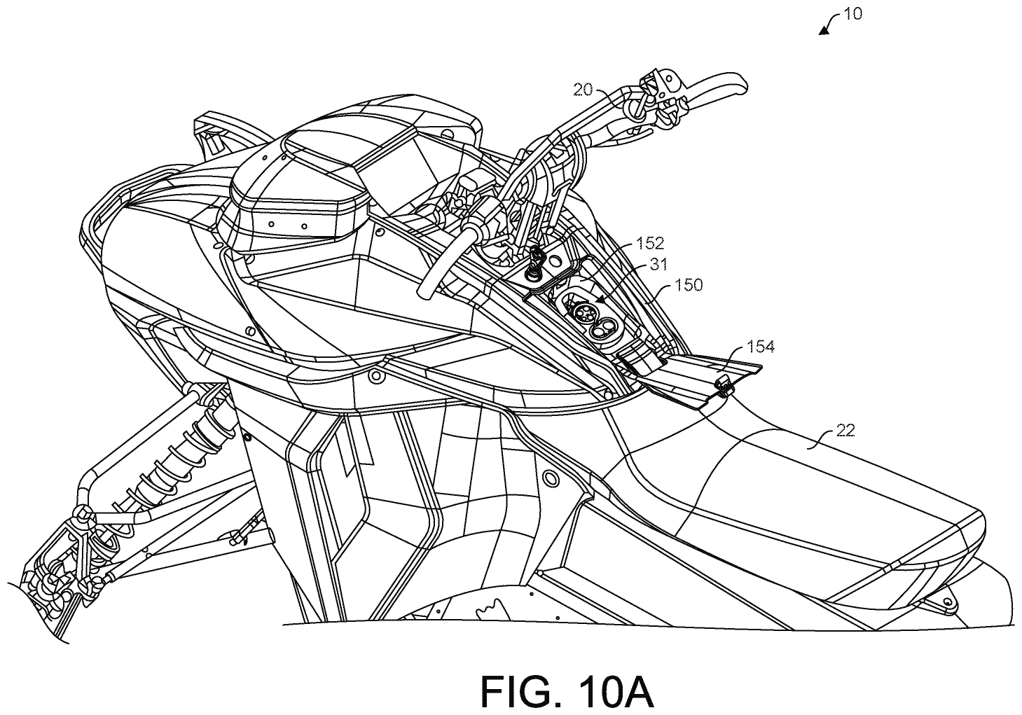

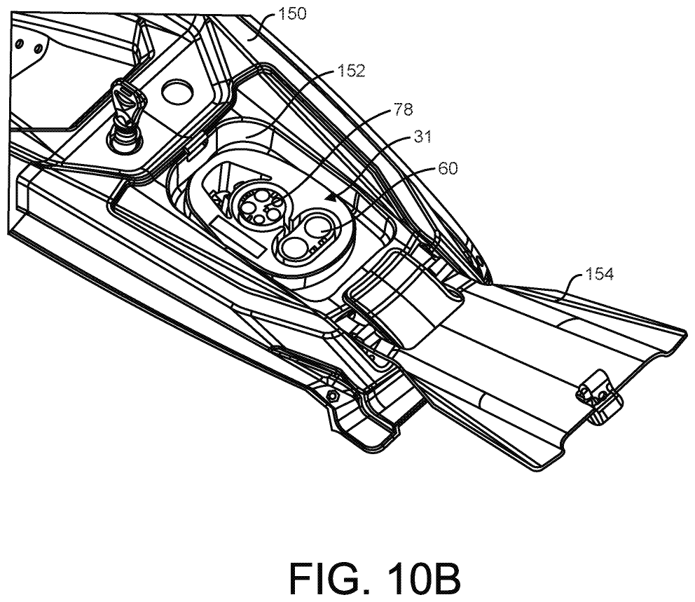

In examples, battery pack 30, in accordance with the present disclosure, includes an enclosure 50 housing a battery 51 comprising a plurality of rechargeable battery modules, such as illustrated at 52, and DC circuitry 54 to electrically connect rechargeable battery modules 52 with one another and to motor 26. In examples, charging port 31 of battery pack 30 is mounted to enclosure 50. In one example, charging port 31 includes a DC charging port 60 which is directly connected to DC circuitry 54 such that all electrical connections between DC charging port 60 and rechargeable battery modules 52 and DC circuitry 54 are contained within interior space 56 of enclosure 50. DC charging port is accessible from an exterior of enclosure 50 and from an exterior of snowmobile 10 (e.g., see FIGS. 10A and 10B), and is configured to receive and electrically connect an external DC charging source to the plurality of rechargeable battery modules 52 via DC circuitry 54. In examples, DC charging port 60 is directly connected to DC circuitry 54 and rechargeable battery modules 52 using bus bars.

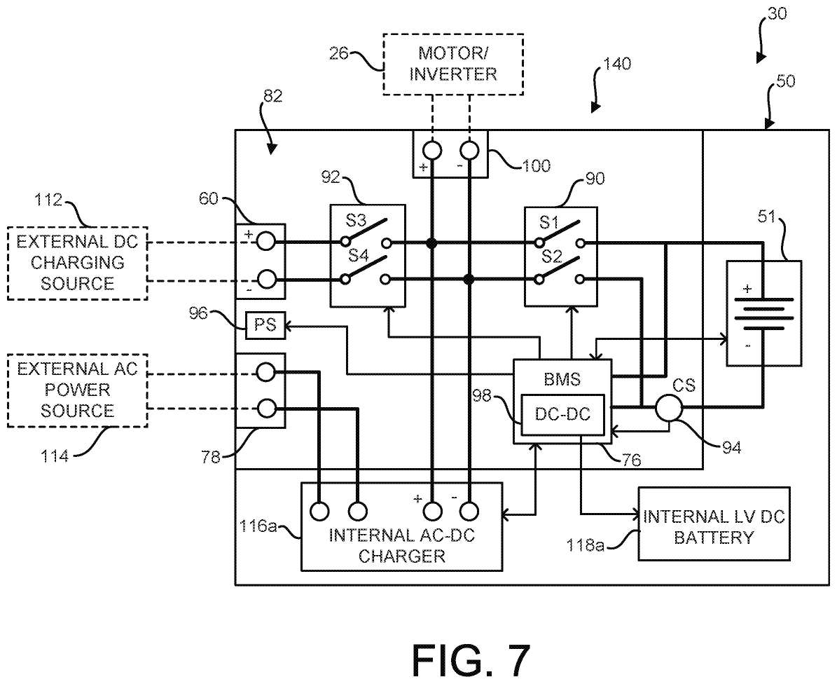

In other examples, as described in greater detail below, charging port 31 may include an AC charging port (e.g., see AC charging port 78 in FIG. 2 below). In some examples, such AC charging port may be directly connected to AC charging circuitry within battery pack 30 (e.g., see AC-DC charger 116a in FIG. 7 below) such that all electrical connections between AC charging port 78, rechargeable battery modules 52 and AC charging circuitry are contained within interior space 56 of enclosure 50.

By directly integrating charging port 31 with battery pack 30, long runs of cabling are eliminated, thereby eliminating electrical losses and potential failure points associated with such cabling (e.g., DC and/or AC cabling). Directly integrating charging port 31 with battery pack 30 further eliminates the space that would otherwise be required with long runs of cable, and also reduces costs and improves the modularity of the battery pack 30.

FIG. 2 is a block and schematic diagram generally illustrating battery pack 30, according to one example of the present disclosure. In examples, battery enclosure 50 defines interior space 56 in which the plurality of rechargeable battery modules 52, illustrated as battery modules 52a-52d, are disposed. In examples, enclosure 50 includes a top plate 62, a bottom plate 64 to which battery modules 52 are mounted, and a housing 66 which together define interior space 56. In one example, top plate 62 is mounted to upper face 58 of battery 51, such as illustrated by upper faces 58a and 58b of battery modules 52, with housing 66 connected about a perimeter 67 (e.g., a perimeter flange) of top plate 62 and about a perimeter of bottom plate 64 to define interior space 56. In examples, enclosure 50 forms a sealed interior space 56. In examples, DC circuitry 54 electrically interconnects the plurality of battery modules 52 with one another, such as schematically illustrated by electrical bus bars 68 interconnecting battery modules 52a-52d, and, as will be described in greater detail below, is configured to connect the plurality of battery modules 52 with electric motor 26 (see FIG. 1A).

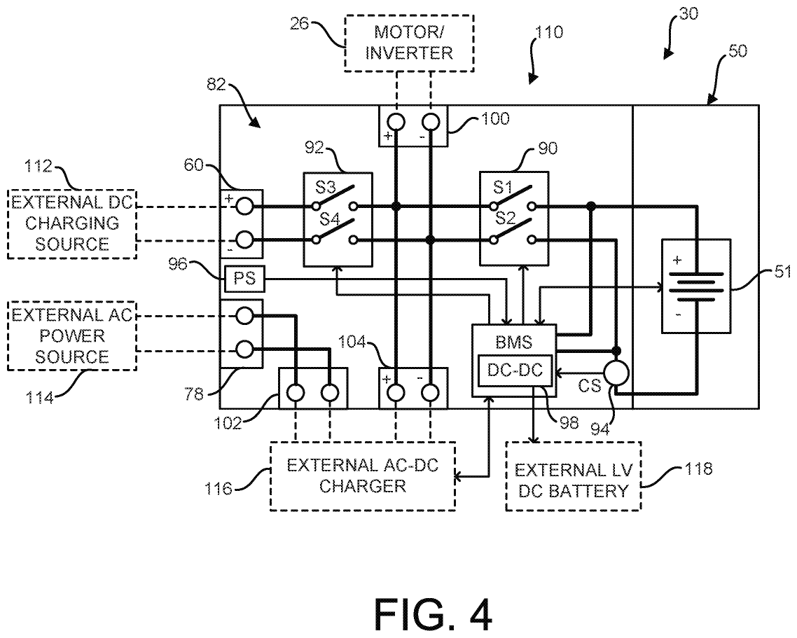

Top plate 62 includes an interior side 70 and an exterior side 72. In examples, DC charging port 60 of charging port 31 is mounted to exterior side 72 and extends through top plate 62 to electrically interconnect with a portion 74 of DC circuitry 54 disposed on interior side 70. In examples, as will be described in greater detail below, DC circuitry 74 disposed on interior side 70 of top plate 62 includes a number of DC contactors and interconnects (e.g., bus bars) which are selectively controllable by a battery management system (BMS) 76 to connect battery 51 with electric motor 26 and an external DC charging source via DC charging port 60 (e.g., see FIGS. 4-7). In examples, BMS 76 is mounted to interior side 70 of top plate 62.

In examples, in addition to DC charging port 60, charging port 31 includes an AC charging port 78 which is mounted to exterior side 72 of top plate 62. As will be described in greater detail below, similar to DC charging port 60, AC charging port 78 is accessible from the exterior of battery enclosure 50 and the exterior of snowmobile 10, and is configured to receive and connect battery pack 30 to an exterior AC power source for charging. In examples, together, top plate 62, charging port 31, including DC charging port 60 and AC charging port 78, DC circuitry 74, and BMS 76 form a top plate assembly 82, where top plate assembly 82 is mounted to upper face 58 of battery 51.

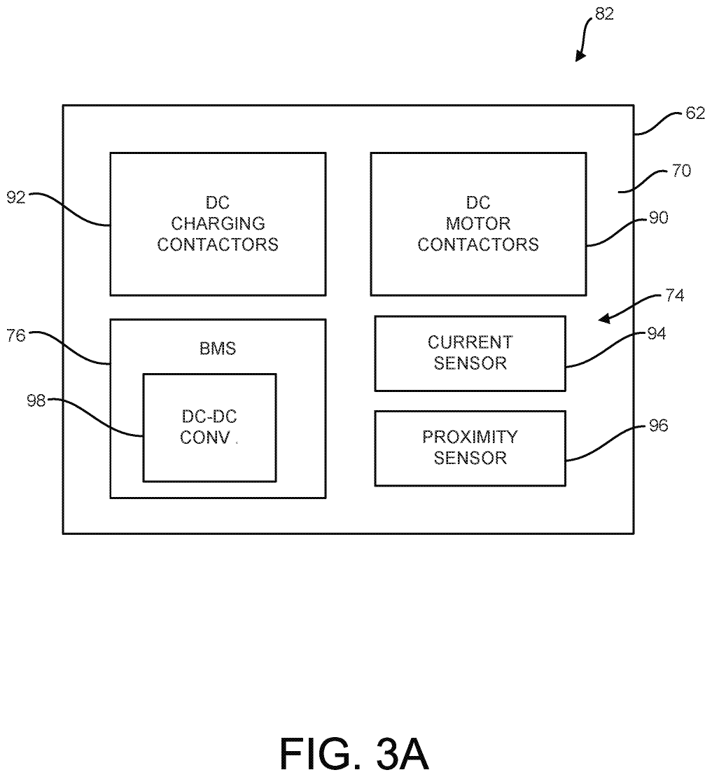

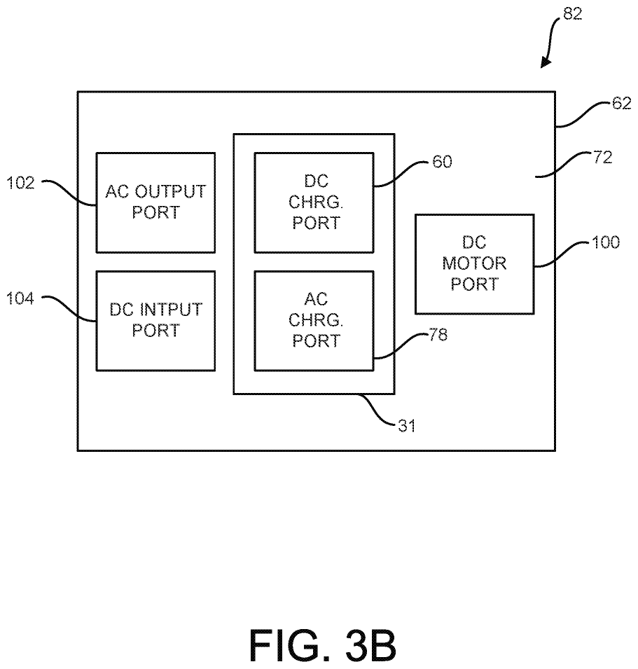

FIGS. 3A and 3B are block and schematic diagrams respectively illustrating interior and exterior sides 70 and 72 of top plate assembly 82, according to one example. Referring to FIG. 3A, in one example, DC circuitry 74 disposed on interior side 70 of top plate assembly 82 includes a pair of DC motor contactors 90, and a pair of DC charging contactors 92. In one example, in addition to BMS 76, interior side 70 also includes a current sensor 94 and a proximity sensor 96. In one case, BMS 76 additionally includes a high-voltage DC to low-voltage DC converter 98 to convert a high voltage DC output from battery 51 (e.g., 300-400 VDC) to a low-voltage DC output (e.g., 12 VDC) to power auxiliary components/systems of snowmobile 10. In other examples, DC-DC converter 98 may be separate from BMS 76.

Referring to FIG. 3B, in one example, in addition to charging port unit 31 having DC charging port 60 and AC charging port 78, exterior side 72 of top plate assembly 82 includes a DC motor port 100 to connect to and provide power to motor 26 from battery 51. In one example, exterior side 72 includes an AC output port 102 and a DC input port 104, where AC output port 102 is configured to connect to and provide AC output power to an external AC-DC charger, and DC input port 104 is configured to connect to and receive DC input power from the external AC-DC charger for charging battery 51 (e.g., see FIGS. 4-6). In other examples, the external AC-DC charger is disposed within battery enclosure 50 so that AC output and DC input ports 102 and 104 are not necessary and are not included as part of top plate assembly 82 (e.g., see FIG. 7).

FIGS. 4-7 are block and schematic wiring diagrams illustrating different electrical interconnection schemes which may be employed between rechargeable battery 51 and components of top plate assembly 82 of battery pack 30, according to examples of the present disclosure. According to interconnect scheme 110 of FIG. 4, battery 51 is connected to DC motor port 100 via motor contactors 90, illustrated as motor contactors S1 and S2, where contactor S1 is coupled to a positive (+) DC lead and contactor S2 is connected to a negative (−) DC lead. DC motor port 100 is configured to connect to and provide DC power from battery 51 to motor 26. In one example, as illustrated, motor 26 is an AC motor having a corresponding DC-AC inverter.

DC charging port 60 is connected to battery 51 via DC charging contactors 92, illustrated as S3 and S4, and DC motor contactors 90. DC charging port 60 is configured to receive and connect external DC charging source 112 to battery 51 via DC charging contactors 92 and DC motor contactors 90. In examples, BMS 76, via proximity switch 96, detects when external DC charging source 112 is connected to DC charging port 60 and closes contactors S1 and S2 of DC motor contactor 90 and contactors S3 and S4 of DC charging contactor 92 to enable DC charging of battery 51. In examples, BMS 76 monitors a temperature level and voltage level of battery 51 and will disable charging of battery 51 if outside a set temperature range and/or above a set voltage level. In examples, each battery modules 52 is formed by a number of series-connected individual battery cells. In one example, BMS 76 monitors a temperature and voltage level of each battery cell and will disable charging of battery 51 is a single cells is outside a set temperature range (e.g., greater than 60° C. and less than 20° C.) and/or above a set voltage level (e.g., greater than 4.2 VDC).

In examples, AC charging port 78 is connected to AC output port 102. AC charging port 78 is configured to receive and connect to an external AC power source 114, and AC output port 102 is configured to receive and connect to an AC input of an external AC-DC charger 116, such that external AC power source 114 is connected to the AC input of external AC-DC charger 116 via AC charging port 78 and AC output port 102. DC input port 104 is connected to an upstream side of DC motor contactors 90 (e.g., between DC motor contactors 90 and DC charging contactors 92). DC input port 104 is configured to receive and connect to a DC output of external AC-DC charger 116 and to provide the DC charging output of external AC-DC charger 116 to battery 51 via DC motor contactors 90.

In examples, battery 51 provides a high voltage DC output voltage, such as in a range of 300-400 VDC, for example. In examples, DC-DC converter 98 receives the high voltage DC output from battery 51 and converts the high voltage DC output to a low-voltage DC output (e.g., 12 VDC) for charging an external low-voltage DC battery 118. In some examples, as illustrated, the low-voltage DC battery 118 is external to battery pack 30. In other examples, low-voltage DC battery 118 is located within battery pack 30 (e.g., see FIG. 7).

In examples, all high voltage DC connections within battery pack 30 are bus bar connections. In other examples, high voltage DC connections within battery pack 30 may be made using both bus bar connections and wires. Relative to wired connections, bus bar connections enable a more compact layout (since bus bars do not require bending radiuses as do wires/cables) and provide reduced electrical losses (since bus bars typically have lower resistance than wires/cables). Bus bar connections are also less susceptible to failure from vibration and impacts relative to wires/cables and, thus, provide a more robust system.

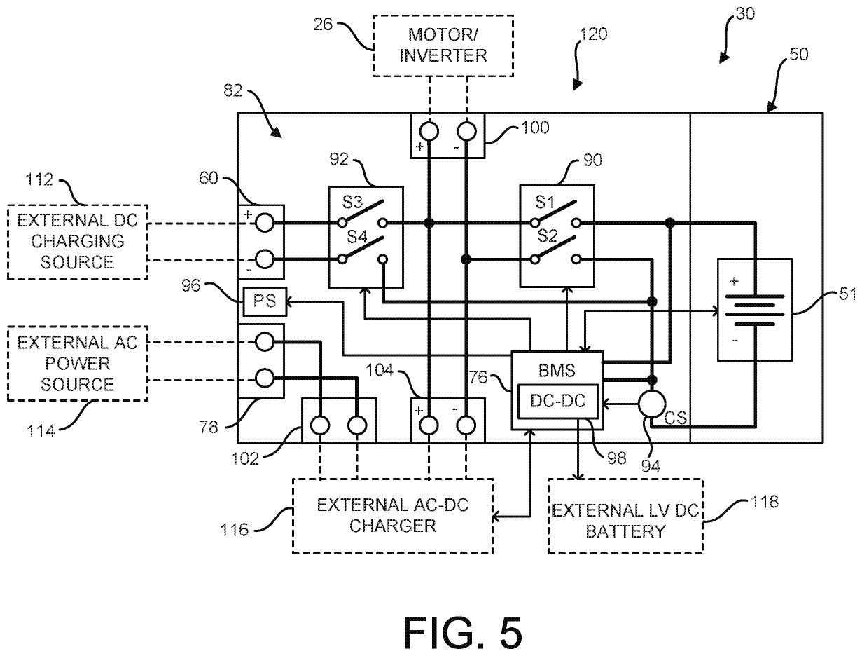

Interconnect scheme 120 of FIG. 5 is similar to interconnect scheme 110 of FIG. 4, except that only the positive DC lead from DC charging port 60 is routed through both DC charging contactors 92 and DC motor contactors 90. As illustrated, the positive DC lead from DC charging port 60 is routed to the positive terminal of battery 51 through positive DC contactor S3 of DC charging contactors 92 and through positive DC contactor S1 of DC motor contactors 90, where the negative lead from DC charging port 60 is routed to the negative terminal of battery 51 only through negative DC contactor S4 of DC charging contractor 60. As a result, interconnect scheme 120 reduces an amount of energy consumed when connecting external DC charging source 114 to battery 51 since only three contactors are operated (S1, S3, S4) rather than four contactors (S1, S2, S3, S4).

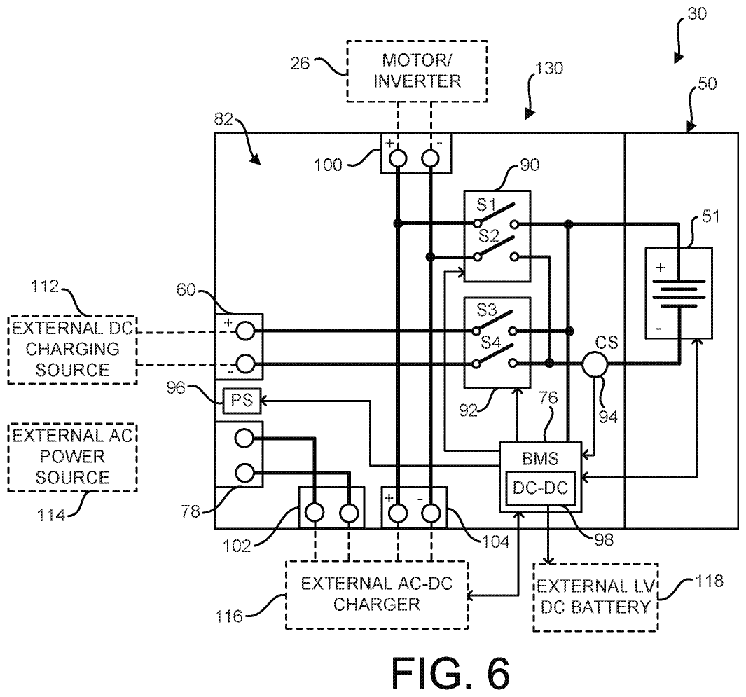

Interconnect scheme 130 of FIG. 6 is similar to interconnect scheme 120 of FIG. 5, except that DC charging port 60 is connected to battery 51 through only DC charging contactors 92, with DC motor contactors 90 being bypassed.

Interconnect scheme 140 of FIG. 7 is similar to interconnect scheme 110 of FIG. 4, except that external AC-DC charger 116 and external low-voltage DC battery 118 are disposed within enclosure 50 as illustrated by internal AC-DC charger 116a and internal low-voltage DC battery 118. As illustrated, with AC-DC charger 116a mounted internally, AC output port 102 and DC input port 104 have been eliminated, relative to implementation 110 of FIG. 4, and AC charging port 78 is connected direction to an AC input of internal AC-DC charger 116a.

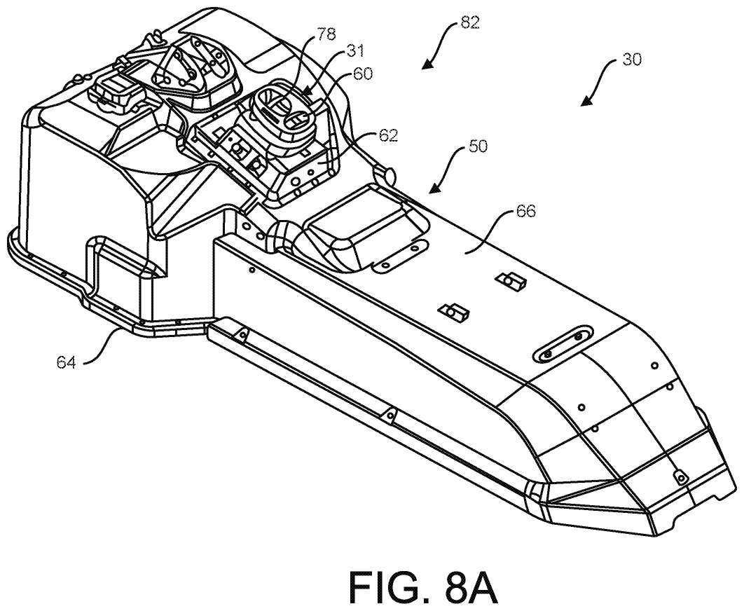

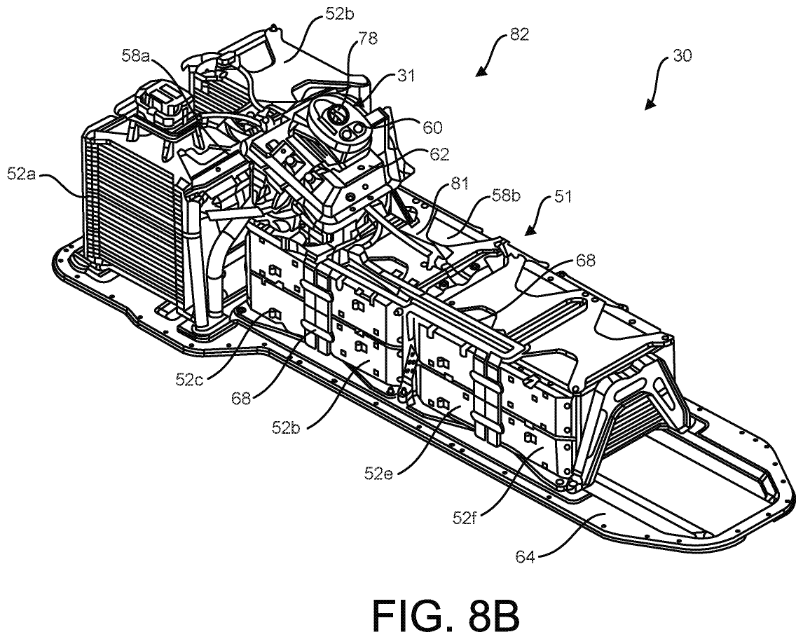

FIGS. 8A and 8B respectively illustrate perspective views of battery pack 30 with and without housing 66. As illustrated by FIG. 8A, housing 66 forms a sealed connection about the perimeter of top plate 62 of top plate assembly 82, with charging port 31 having DC charging port 60 and AC charging port 78 accessible from an exterior of enclosure 50. In examples, top plate assembly 82 is mounted directly to upper faces 58a and 58b of battery modules 52.

With reference to FIG. 8B, the plurality of battery modules 52, such as illustrated by battery modules 52a-52f, are mounted to base plate 64 of housing 50. In examples, each battery modules 52 includes a plurality of battery cells which are stacked and interconnected with one another to form the corresponding battery module 52. The plurality of battery modules 52 are interconnected (e.g., daisy-chained), such as via electrical bus bar 68, to form battery 51. In one example, each battery cell is a prismatic battery cell. In another example, each battery cell is a pouch battery cell. In another case, each battery cell is a lithium ion battery cell. In examples, battery modules 52 are interconnected such that battery 51 provides a desired high voltage DC output to motor 26. In examples, battery modules 52 may be interconnected to provide a desired high voltage DC output within a range from 300-400 VDC. A grounding conductor 81 connects charging port 31 to ground.

In examples, each battery module 52 may include multiple types of sensors for sensing various operating parameters, such as one or more temperature sensors and/or one or more voltage sensors, for instance. In examples, the sensed temperature and/or voltage may be for one, or for multiple, battery cells within each battery module 52. As described above, such sensed temperatures and voltages may be monitored by BMS 78 as inputs to control the opening and closing of DC motor contactors 90 and DC charging contactors 90.

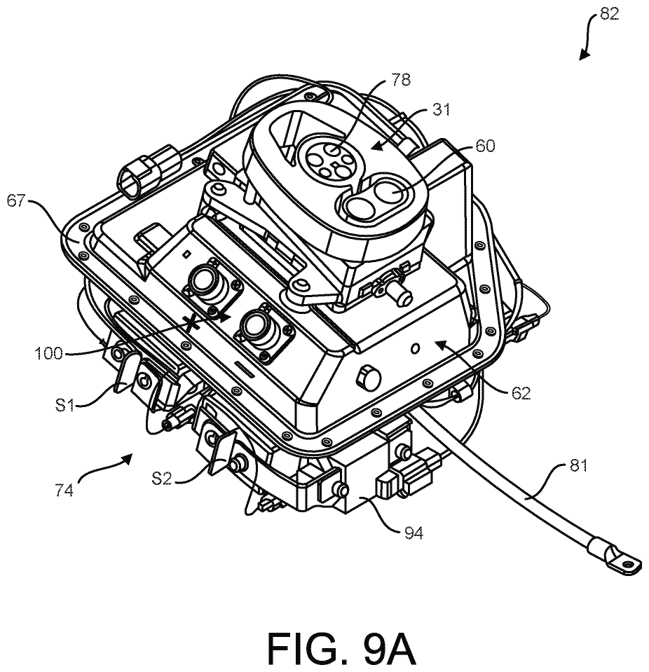

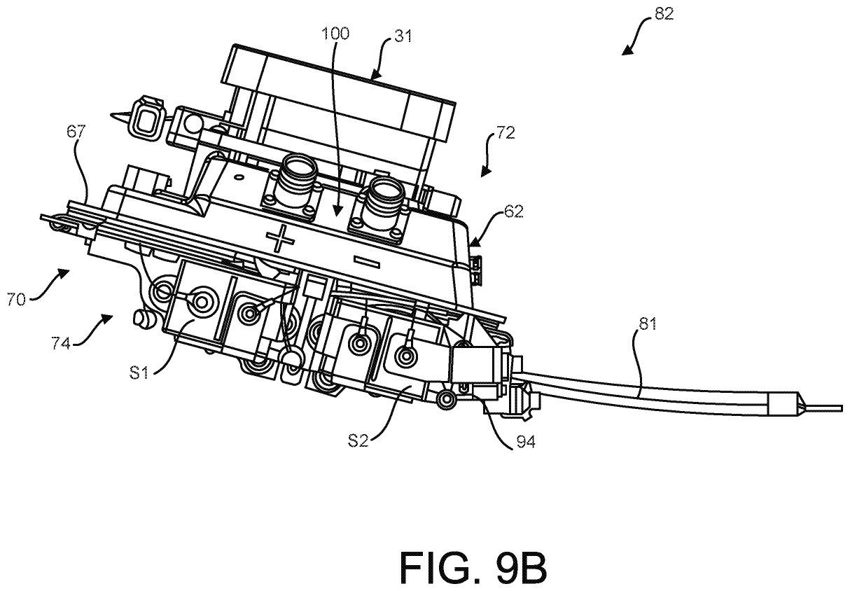

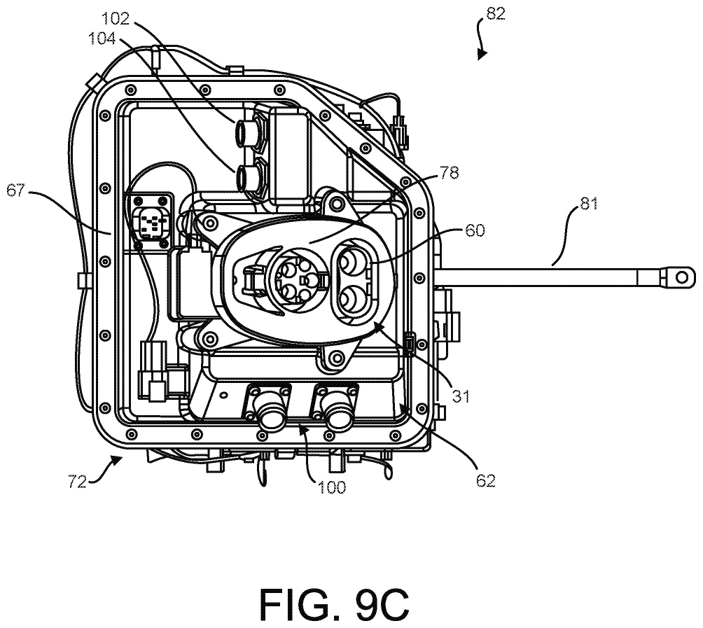

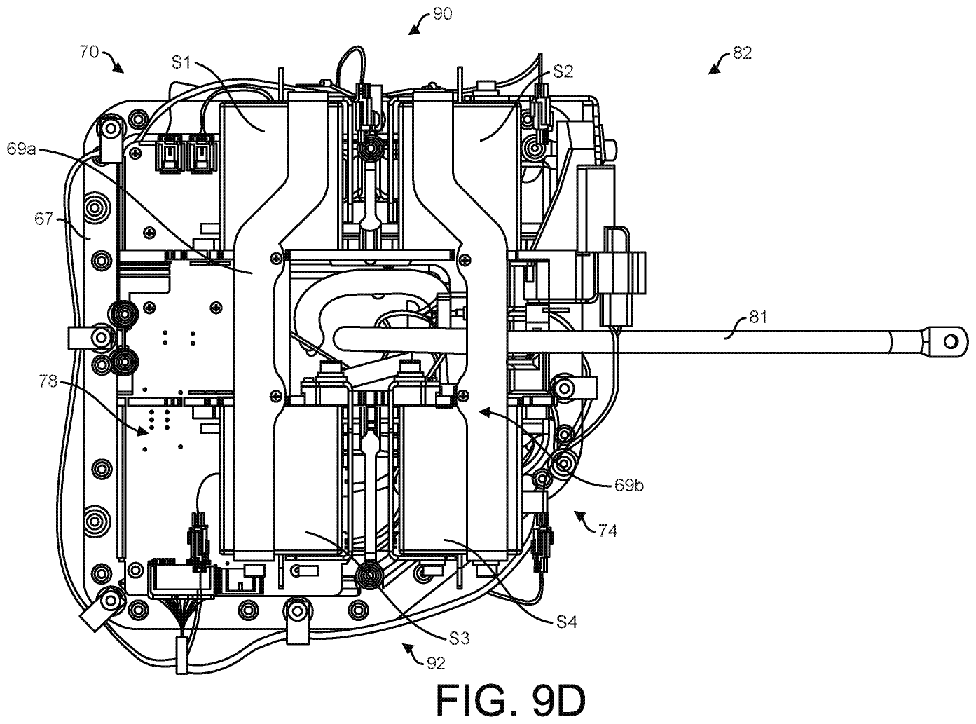

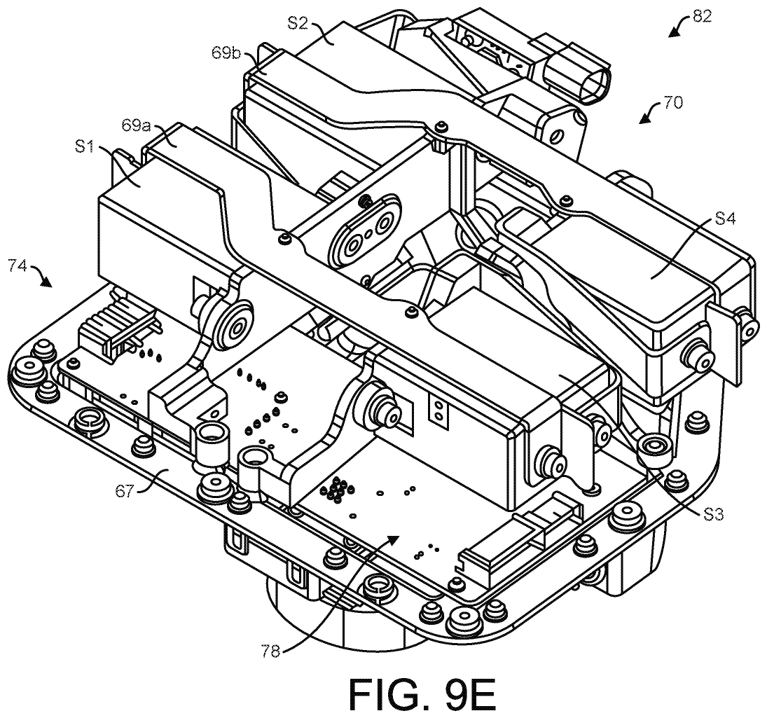

FIGS. 9A-9E respectively illustrate a top perspective view, a side view, a top view, a bottom view, and a bottom perspective view of a top plate assembly, according to one example. According to the illustrated example, charging port 31, including DC charging port 60 and AC charging port 78, DC motor port 100 (comprising a “+” and a “−” connection), and AC output and DC input ports 102 and 104 for connection to external AC-DC battery charger 116 (e.g., see FIG. 4) are disposed on exterior side 72 of top plate 62. DC circuitry 74, including DC motor contactors 90, including contactors S1 and S2, DC charging contactors 92, including contactors S3 and S4, current sensor 94, and DC interconnects, such as bus bars 69a and 69b respectively interconnecting contactors S1-S3 and S2-S4, are disposed on interior side 70 of top plate 62. BMS 78 is also disposed on interior side 70 of top plate 62.

FIG. 10A is a perspective view of portions of an electric snowmobile, such as snowmobile 10 of FIG. 1A, including a charging port 31, according to one example. FIG. 10B is an enlarged perspective view of charging port 31 of snowmobile 10 of FIG. 10A, according to one example. According to one example, as illustrated, when battery pack 30 is mounted within snowmobile 10, charging port 31 is positioned so as to be forward of seat 22, and between handlebar 20 and seat 22. In one example, charging port 31 extends through a body 150 of snowmobile 10 and is disposed within a recess 152 therein. A hinged cover 154 may pivot from a closed position to an open position to expose DC charging port 60 and AC charging port 78 of charging port 31 to readily enable connection to exterior charging sources (e.g., external DC charging source 112 and external AC power source 114). It is noted that hinged cover 154 is illustrated in an open position in FIGS. 10A and 10B.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A battery pack for an electric vehicle comprising:
a plurality of rechargeable battery modules;
DC circuitry to electrically connect the plurality of rechargeable battery modules to an electric motor of the electric vehicle;
an enclosure housing the plurality of battery modules and DC circuitry; and
a DC charging port mounted to the enclosure and directly connected to the DC circuitry, the DC charging port accessible from an exterior of the enclosure and configured to receive and electrically connect an external DC charging source to the plurality of rechargeable battery modules via the DC circuitry.

2. The battery pack of claim 1, the DC circuitry including a pair of controllable DC charging contactors, the DC charging port electrically connected to the plurality of rechargeable battery modules via at least the pair of controllable DC charging contactors.

3. The battery pack of claim 1, the DC charging port electrically connected to the DC circuitry via bus bars.

4. The battery pack of claim 2, further including:
a DC motor port mounted to the enclosure and electrically connected to the DC circuitry, the DC circuitry including a pair of controllable DC motor contactors, the DC motor port accessible from an exterior of the enclosure and configured to connect the electric motor to the plurality of rechargeable battery modules via the pair of controllable DC motor contactors.

5. The battery pack of claim 4, the DC charging port to electrically connect the external DC charging source to the plurality of rechargeable battery modules via the pair of DC charging contactors and the pair of DC motor contactors.

6. The battery pack of claim 4, the pair of DC charging contactors and the pair of DC motor contactors each having a positive lead contactor and a negative lead contactor, wherein a positive lead of the DC charging port is electrically connected to a positive terminal of the plurality of rechargeable battery modules via the positive lead contactors of both the pair of DC charging contactors and the pair of DC motor contactors, and a negative lead of the DC charging port is electrically connected to a negative terminal of the plurality of rechargeable battery modules via the negative lead contractor of the pair of DC charging contactors.

7. The battery pack of claim 4, further comprising:
a battery management system including:
a proximity sensor to detect whether the external DC charging source is connected to the DC charging port; and
a controller to close the DC charging contactors when the proximity sensor indicates connection of the external DC charging source.

8. The battery pack of claim 4, further including an AC charging port mounted to the enclosure and accessible from the exterior thereof, the AC charging port to connect an external AC power source to an AC-DC charger, wherein a DC output of the AC-DC charger is in electrical communication with the DC charging circuitry to charge the plurality of rechargeable battery modules.

9. The battery pack of claim 8, further including:
an AC output port mounted to the enclosure and directly connected to the AC charging port; and
a DC input port mounted to the enclosure and directly connected to the DC motor port, the AC output port and DC input port each accessible from the exterior of the enclosure, the AC-DC charger external to the battery pack, the AC output port configured to connect to an AC input of the external AC-DC charger and the DC input port configured to connect to a DC output of the external charger.

10. The battery pack of claim 9, the enclosure including a top plate, wherein the DC charging port, AC charging port, DC motor port, AC output port, DC input port, DC charging contactors, and DC motor contactors are mounted to the top plate to form a top plate assembly, wherein the top plate assembly is mounted to the plurality of rechargeable battery modules, and wherein remaining portions of the enclosure are mounted about and form a sealed connection with a perimeter flange of the top plate.

11. The battery pack of claim 8, further including:
an AC-DC charger disposed within the enclosure and including an AC input and a DC output, the AC charging port electrically connected to the AC input, and the DC output electrically connected to the DC motor port.

12. The battery pack of claim 8, wherein the DC charging port and AC charging port are configured to prevent simultaneous connection to the external DC charging source and external AC power source.

13. The battery pack of claim 1, further including:
a low-voltage DC battery disposed within the enclosure; and
the DC circuitry including a DC-DC converter to convert a high-voltage DC output of the plurality of battery modules to the low-voltage of the low-voltage DC battery to charge the low-voltage DC battery.

14. An electric power sport vehicle comprising:
a body;
an electric motor disposed within the body for propelling the vehicle; and
a battery pack disposed within the body for powering the electric motor, the battery pack including:
a plurality of rechargeable battery modules;
DC circuitry to electrically connect the plurality of rechargeable battery modules to the electric motor, the DC circuitry including a pair of DC charging contactors;
an enclosure housing the plurality of battery modules and DC circuitry; and
a DC charging port mounted to the enclosure and directly connected to the DC circuitry, the DC charging port accessible from an exterior of the enclosure and from an exterior of the body and configured to receive and electrically connect an external DC charging source to the plurality of rechargeable battery modules via at least the pair of DC charging contactors.

15. The electric power sport vehicle of claim 14, the DC circuitry including a pair of controllable DC motor contactors to electrically connect the plurality of rechargeable battery modules to the electric motor, the DC charging port to connect the external DC charging source to the plurality of rechargeable battery modules via the pair of DC charging contactors and at least one contactor of the pair of DC motor contactors.

16. The electric power sport vehicle of claim 15, further including:
an AC-DC charger disposed within the body including:
an AC input; and
a DC output electrically connected to the DC circuitry configured to connect to and charge the plurality of rechargeable battery modules via the pair of DC motor contactors; and
the battery pack further including an AC charging port mounted to the enclosure and accessible from the exterior thereof, the AC charging port to connect an external AC power source to the AC input of the AC-DC charger.

17. The electric power sport vehicle of claim 14, the electric powersport vehicle comprising a snowmobile.

18. A battery pack to power an electric motor of an electric powersport vehicle comprising:
a plurality of rechargeable battery modules;
a top plate assembly including:
a top plate having an upper surface and a lower surface;
DC circuitry to electrically connect the plurality of rechargeable battery modules to the electric motor and including a pair of controllable DC charging contactors, the top plate assembly mounted to the plurality of rechargeable battery modules with the DC circuitry electrically connected to the plurality of rechargeable battery cells, the lower surface facing the plurality of rechargeable battery modules; and
a DC charging port mounted to the upper surface, the DC charging port extending through the top plate and electrically connected to the DC circuitry; and
a housing forming a sealed connection about a perimeter edge of the top plate such that the top plate and housing together form an enclosure defining an interior space enclosing the plurality of rechargeable battery cells and the DC circuitry, the DC charging port is accessible form the exterior of the enclosure and configured to receive and electrically connect an external DC charging source to the plurality of rechargeable battery modules via the controllable DC charging contactors.

19. The battery pack of claim 18, the DC charging port electrically connected to the DC circuitry with bus bars.

20. The battery pack of claim 18, the DC circuitry including a pair of controllable DC motor contactors to connect the plurality of rechargeable battery modules to the electric motor, the DC charging port to connect the external DC charging source to the plurality of rechargeable battery modules via the controllable DC charging contactors and at least one of the pair of controllable DC motor contactors.

21. The battery pack of claim 20, further including a DC motor port mounted to the upper surface of the top plate, the DC charging port extending through the top plate and electrically connected to the DC circuitry, the DC charging port to electrically connect the electric motor to the DC circuitry and to the plurality of rechargeable battery modules via the pair of controllable DC motor contactors.

22. The battery pack of claim 18, further including an AC charging port mounted to the upper surface of the top plate and configured to electrically connect an external AC power source to an AC-DC charger.

23. The battery pack of claim 22, the AC-DC charger disposed within the interior space of the enclosure, the AC charging port electrically connected to an AC input of the AC-charger and a DC output of the AC-DC charger electrically connected to the DC circuitry.

24. The battery pack of claim 22, the DC charging port and AC charging port together forming a charging port unit, wherein the charging port unit is configured to prevent simultaneous connection of the external DC charging source and the external AC power source.
